(19) United States
(12) Patent Application Publication
(10) Pub. No.: US 2004/0122975 A1
(43) Pub. Date: Jun. 24, 2004

(54) Communication of electronic data via a network infrastructure

(76) Inventors: Hakan Lennestal, Lulea (SE); Jim Sunqvist, Lulea (SE); Tommy Arngren, Sodra Sunderbyn (SE)

Correspondence Address: Stanley R Moore, Jenkens & Gilchrist, Suite 3200, 1445 Ross Avenue, Dallas, TX, 75202-2799, US

(21) Appl. No.: 10/468,930

(22) PCT Filed: Feb. 21, 2002
(86) PCT No.: PCT/SE02/00299

(30) Foreign Application Priority Data
Feb. 23, 2001 (SE) 0100633-7

(51) Int. Cl. H04L 12/16; H04Q 11/04

(52) U.S. Cl. 709/245; 709/247

(57) ABSTRACT

An apparatus and method for communicating electronic data via a network infastructure (101) having a unicast mechanism and a multicast mechanism. Said apparatus comprises a server (100), which contains electronic data and is capable of using said unicast and multicast mechanisms for communicating said electronic data to one or more clients (102), the apparatus comprises means (103) adapted to make a decision, taking into account a predetermined set of parameters, whether said server (100) shall use said unicast mechanism or said multicast mechanism for communicating said electronic data to said clients (102) and said server (100) is arranged to communicate said electronic data to said clients (102) in accordance with said decision.

### FIELD OF THE INVENTION

The present invention relates broadly to the field of communication of electronic data between server and client via a network infrastructure.

### DESCRIPTION OF RELATED ART

Presently, communication of electronic data via network infrastructures is widely used for various purposes. In recent years there has been a rapid increase in products and services provided via network infrastructures in general, but first and foremost via the Internet, i.e. the well-known global collection of interconnected networks using Transmission Control Protocol/Internet Protocol (TCP/IP) protocols. For example, one increasingly popular application where electronic data is communicated via a network infrastructure is on-demand supply of different kinds of multimedia, such as music and video. That is, electronic data representing the multimedia is communicated from a source, for instance a server, to a recipient, for instance a client, upon a request by the recipient.

There are different ways of communicating electronic data from a source to one or more recipients, unicast and multicast being two frequently used alternatives.

The term “unicast” denotes communication of electronic data from one source to one single recipient, which is the most common type of communication.

The term “multicast” refers to communication of electronic data from one source to a group of recipients, i.e. the network multicast group. Multicasting is an efficient way of communicating data to multiple recipients in that data sent from the source is only copied where the paths in the network diverge. Thus, only one copy of the data will pass any link in the network and, accordingly, less bandwidth is used compared to communicating the same data to each recipient using unicast.

Even though the number of multicast applications is increasing, unicast is still the most common way of communicating data. Consequently, there is a great waste of bandwidth due to use of unicast when multicast would be preferred. On the other hand, using multicast for data communication is not always efficient with respect to the use of network resources, for instance in case of only a few recipients.

Thus, there is a need for more efficient use of available network resources when communicating data to a number of recipients.

When multicasting electronic data to multiple recipients, achieving secure data communication is a problem. Since only one copy of the data is sent from the source to all recipients, the data is encrypted using the same encryption key for all recipients. Thus, all recipients use the same key for decoding the encrypted data. Consequently, most of the proposed solutions addressing the problem of secure multicasting are based on secure distribution to the recipients of the group key, i.e. the encryption key shared by source and recipient for encryption of the multicast data. Public-key encryption can of course be utilized, in which case the same private key will be used by all recipients. However, all clients sharing the same encryption key enables unauthorized copying and distribution of encryption keys, which constitutes a problem needing to be addressed.

Another problem of secure multicasting of data is to obtain a scalable solution, i.e. a solution that efficiently handles large group sizes and frequent changes in the number of recipients.

U.S. Pat. No. 5,748,736 describes a system and method for secure group communications via multicast or broadcast. By using so called trusted intermediary (TI) servers to create a hierarchy of secure multicast networks, a scalable solution is achieved. However, the problem of unauthorized copying and distribution of encryption keys remains for each secure sub-network in said hierarchy.

As stated above, multicast is advantageous for communicating electronic data to multiple recipients. However, when using multicast, the data is communicated simultaneously to all recipients. Thus, there is a problem in providing on-demand functionality when using multicast, since different recipients may request the same data at different times.

### SUMMARY OF THE INVENTION

A first object of the present invention is to provide a solution for communicating electronic data from a server to one or more clients via a network infrastructure, which better utilizes the available resources in said network infrastructure.

According to one aspect of the present invention this first object is achieved by an apparatus for communicating electronic data via a network infrastructure as initially described, which comprises means adapted to make a decision, taking into account a predetermined set of parameters, whether said server shall use said unicast mechanism or said multicast mechanism for communicating said electronic data to said clients and that said server is arranged to communicate said electronic data to said clients in accordance with said decision. The ability to choose between unicast and multicast thus enables a more efficient utilization of available resources in said network infrastructure. Said parameters define when to use multicast and when to use unicast for communicating said data so that the resources in said network infrastructure are used in an advantageous manner.

According to another aspect of the invention the first object is achieved by a method for communicating electronic data as initially described, comprising the steps of making a decision, taking into account a predetermined set of parameters, whether to use said unicast mechanism or said multicast mechanism for communicating said electronic data to said clients, and controlling said server to communicate said electronic data to said clients in accordance with said decision.

According to yet another aspect of the invention the first object is achieved by a computer program directly loadable into the internal memory of a computer, comprising software for controlling the method described in the above paragraph when said program is run on the computer.

According to a further aspect of the invention the first object is achieved by a computer readable medium, having a program recorded thereon, where the program is to make a computer control the method described in the penultimate paragraph above.

A second object of the invention is to provide secure multicasting of electronic data, while avoiding the problems stated above.

According to one aspect of the present invention this second object is achieved by a method for secure multicasting of electronic data as initially described, comprising the steps of: obtaining a first data encryption key, calculating a second data encryption key for each of said clients through a predetermined operation using a unique client identifier and said first data encryption key, communicating said second data encryption keys to each respective client, encrypting the electronic data to be communicated using a third data encryption key corresponding to the difference between said first and second data encryption keys according to said predetermined operation, communicating the encrypted electronic data to each respective client, creating said third data encryption key at each of said clients using said first and second data encryption keys, and decrypting the communicated electronic data at each of said clients using said third data encryption key. In this way, each client receives a unique encryption key, which prevents unauthorized distribution of encryption keys. Furthermore, since said data is encrypted with the same encryption key for all clients, this solution is scalable.

According to yet another aspect of the invention the second object is achieved by a computer program directly loadable into the internal memory of a computer, comprising software for controlling the method described in the above paragraph when said program is run on the computer.

According to a further aspect of the invention the second object is achieved by a computer readable medium, having a program recorded thereon, where the program is to make a computer control the method described in the penultimate paragraph above.

According to still a further aspect of the invention the second object is achieved by a system for secure multicasting of electronic data as initially described, in which each of said clients is adapted to communicate a first data encryption key to a device, said device is adapted to calculate a second data encryption key for each of said clients through a predetermined operation using a unique client identifier and said first data encryption key, said device is adapted to communicate said second data encryption keys to each respective client, said server is adapted to encrypt the electronic data to be communicated using a third data encryption key corresponding to the difference between said first and second data encryption keys according to said predetermined operation, said server is adapted to communicate the encrypted electronic data to each respective client, each of said clients is adapted to create said third data encryption key using said first and second data encryption keys, and each of said clients is adapted to decrypt the communicated electronic data using said third data encryption key.

A third object of the invention is to provide at least nearly on-demand functionality when using multicast for communicating electronic data.

According to one aspect of the present invention this third object is achieved by a method for multicasting electronic data from a server to one or more clients via a network infrastructure, in which said multicast electronic data is looped. In this way, it is possible for each client to start receiving the multicast electronic data from the beginning of the loop.

According to a preferred embodiment of the invention, a method as described in the above paragraph is provided, in which a plurality of data streams containing electronic data representing the same media content are multicast, each data stream is multicast to a different multicast address, and each data stream starts at a time different from the starting time of any other of said data streams. This enables each client to select which one of the plurality of data streams to receive, i.e. which multicast group to join. Having a plurality of looped data streams to choose from, each client may select to start receiving the multicast electronic data from the data stream, which first reaches the beginning of the loop.

According to yet another aspect of the invention the third object is achieved by a computer program directly loadable into the internal memory of a computer, comprising software for controlling the method described in the above paragraph and the penultimate paragraph above when said program is run on the computer.

According to a further aspect of the invention the third object is achieved by a computer readable medium, having a program recorded thereon, where the program is to make a computer control the method described in the penultimate paragraph above and the last paragraph but two above.

According to still another aspect of the invention the third object is achieved by providing a system for multicasting electronic data via a network infrastructure as initially described, in which said server is adapted to multicast said electronic data in a looped manner.

According to a preferred embodiment of the invention, a system as described in the above paragraph is provided, in which said server is adapted to multicast a plurality of data streams containing electronic data representing the same media content, said server is adapted to multicast each data stream to a different multicast address, and each data stream is arranged to start at a time different from the starting time of any other of said data streams.

A fourth object of the invention is to provide better media quality for clients, which receive electronic data representing media content from a server.

According to one aspect of the present invention this fourth object is achieved by a method for multicasting electronic data as initially described, comprising the steps of: encoding a plurality of data streams containing electronic data representing the same media content according to a layered encoding so that each of said data streams is encoded with a common base layer and a unique enhancement layer different from the enhancement layer of any other of said data streams, multicasting each of said data streams to a different multicast address, and combining the base layer of one data stream with enhancement layers from at least two different of said data streams. By combining several enhancement layers, a higher media quality is achieved compared with receiving only one of said data streams.

Further advantages as well as advantageous features of the invention will appear from the following description and dependent claims.

### BRIEF DESCRIPTION OF THE DRAWINGS

With reference to the appended drawings, below follows a specific description of preferred embodiments of the invention cited as examples.

FIG. 1 shows an apparatus for communicating electronic data via a network infrastructure according to a preferred embodiment of the invention,

FIG. 2 shows an apparatus for communicating electronic data via a network infrastructure according to another preferred embodiment of the invention,

FIG. 3 illustrates, by means of a flow diagram, a general method according to the invention for communicating electronic data via a network infrastructure,

FIG. 4 shows a system for secure multicasting of electronic data according to a preferred embodiment of the invention,

FIG. 5 shows a system for secure multicasting of electronic data according to another preferred embodiment of the invention,

FIG. 6 illustrates, by means of a flow diagram, a general method according to the invention for secure multicasting of electronic data, and

FIG. 7 shows a system for multicasting electronic data according to the invention.

### DESCRIPTION OF PREFERRED EMBODIMENTS OF THE INVENTION

As will become evident to persons skilled in the art, features and aspects of the present invention may be implemented by any suitable combination of hardware, software and/or firmware. In accordance with the present invention, a server may comprise for example, one or more processors, long-term storage devices and short-term storage devices, communication means, application programs etc. Said storage devices may store electronic data, such as application software, database tables, audio, video etc for communication thereof to clients. All parts mentioned may be of any suitable kind. The client may comprise one or more processors, short-term and long-term storage devices, communication means, and suitable application programs. While applicable to all types of electronic data transfer, the present invention is particularly applicable to on-demand distribution and delivery of real-time data, such as audio and video. The term “real-time” refers to the requirement of timely transmission and delivery of said data.

FIG. 1 illustrates an apparatus for communicating electronic data via a network infrastructure 101 according to a preferred embodiment of the present invention. The network infrastructure 101 may comprise a Transmission Control Protocol/Internet Protocol (TCP/IP) network such as the Internet. For transmission of real-time data such as digitized audio or video via said network preferably the Real-Time Transport Protocol (RTP) is used. Preferably, also the protocol designed to work in conjunction with RTP and known as the Real-Time Control Protocol (RTCP) is utilized to get feedback on quality of data transmission and information about participants in on-going sessions of data transmission. Furthermore, said network 101 provides a unicast mechanism and a multicast mechanism. Said apparatus comprises a server 100, which contains electronic data. That is, the server 100 has electronic data stored in storage devices. The electronic data may represent any kind of information that may be stored in storage devices. For example, said electronic data may be real-time data such as audio or video data. Preferably, the data may be separate data streams representing specific media content, such as for instance audio and video clips, making the server a media server, i.e. a provider of media content. It is pointed out that this is only one kind of data for which the invention is suitable and that any other data also could be communicated by means of the apparatus according to the invention.

Furthermore, three clients 102 are shown in FIG. 1. It is to be understood that at any given time the number of clients may be more or less than three. Said clients 102 and said server 100 is connected to the network infrastructure 101. The network connections are formed via suitable connections means, which are known per se and will therefore not be described further. Said server 100 is capable of using said unicast and multicast mechanisms for communicating said electronic data to one or more clients 102. Said apparatus comprises means 103 adapted to make a decision, taking into account a predetermined set of parameters, whether the server 100 shall use -said unicast mechanism or said multicast mechanism for communicating said electronic data to the clients 102 and the server 100 is arranged to communicate said electronic data to the clients 102 in accordance with said decision. In this way, a better utilization of the available resources in the network infrastructure 101 is achieved. In the embodiment illustrated in FIG. 1 said means 103 is included in said server 100.

The clients 102 make requests to the server 100, via the network infrastructure 101, for electronic data to be communicated. According to a preferred embodiment of the present invention said means 103 is adapted to make said decision based on the number of client requests or said electronic data to be communicated from the server 100 per unit of time as one of said parameters. Preferably, said means 103 is adapted to decide for said multicast mechanism to be used for communicating said electronic data to the clients 102 when said number of client requests for said electronic data to be communicated from the server 100 per unit of time is ≧2 and otherwise for said unicast mechanism to be used. That is, when the number of client requests to the server 100 for data to be communicated to the clients 102 increases, the decision is preferably to use said multicast mechanism for communicating the data to the clients 102. Accordingly, when there is less than two requests per unit of time to the server, unicast is preferably used for communicating said data to the clients 102.

According to another preferred embodiment of the present invention said means 103 is adapted to make said decision based on the number of client requests for a portion of said electronic data to be communicated from the server 100 as one of said parameters. As stated above, but not limiting the invention in any way, the data is preferably contained in the server as individual data streams representing specific media content such as audio clips or video clips. Accordingly, the means 103 is preferably adapted to make said decision based on the number of client requests for an individual data stream to be communicated from said server as one of said parameters. Preferably, when there is two or more client requests for said portion of said electronic data to be communicated from the server 100, the decision is for said multicast mechanism to be used for communicating said portion to the clients 102. This is achieved in that the means 103 is adapted to decide accordingly.

According to another preferred embodiment of the invention, the means 103 is adapted to make said decision based on the number of client requests for said electronic data to be communicated from the server 100 within the same distance from the server 100 as one of said parameters. This means that the relative distance between the server 100 and each client 102 is to be considered when making said decision. The distance is of course not necessarily the physical distance between the server 100 and the client 102. The distance referred to is the distance in the network infrastructure 101. Preferably, said distance is defined by a TTL (Time To Live) value. The TTL-technique is used in best effort delivery systems to avoid endlessly looping packets. Each data item, for example an IP-datagram, is assigned a TTL-value, i.e. a time to live. This value is decreased by each router that the data reaches. Said means 103 is preferably adapted to decide for said multicast mechanism to be used for communicating the data to the clients 102 when the number of client requests for the data to be communicated from the server 100 within the same distance from the server 100 is ≧2 and otherwise for said unicast mechanism to be used.

Furthermore, according to another preferred embodiment of the invention, the means 103 is adapted to make said decision based on available server output bandwidth as one of said parameters. The means 103 is preferably adapted to decide for said multicast mechanism to be used when the available server output bandwidth is less than that required to communicate further electronic data as a response to a client request and otherwise for said unicast mechanism to be used.

The condition referred to in the above paragraph is the following. When the server 100 already is occupied with communicating electronic data to clients so that the remaining bandwidth not allows another unicast connection to be established between the server 100 and a client 102 upon a request, the decision should be to switch from using unicast for communicating electronic data to using said multicast mechanism for communicating electronic data to the client 102.

It will be appreciated by persons skilled in the art that none of the above mentioned parameters is to be considered alone when making said decision. All of the parameters above are preferably considered together when making the decision whether to use said multicast or unicast mechanism. The decision shall of course be made so that the available resources in the network infrastructure 101 are used in the best way possible at all times. Thus, the parameters are not to be construed as to limit the invention in any way. For example, when considering the number of client requests for a portion of the electronic data contained in the server 100, for instance an individual data stream representing a video or audio clip, the number of requests should be considered also with respect to the time of the request so that the decision is to use said multicast mechanism when there are two or more requests for the same portion of electronic data per unit of time. Preferably said requests should also stem from clients within a certain time to live value with respect to the server 100. However, if there are few, for instance two, requests for the same portion of electronic data stemming from clients far away from the server 100, it may be advantageous to establish two unicast connections instead of using multicast for communicating said data. Thus, the parameters are preferably not considered individually, but together to achieve advantageous use of the available resources in the network infrastructure.

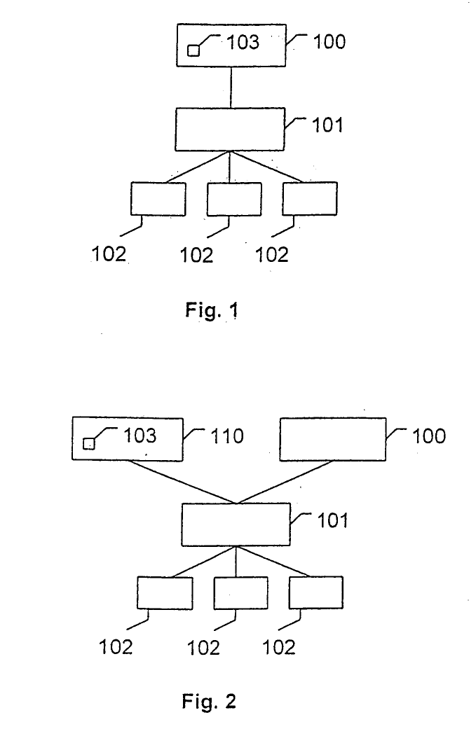

Referring now to FIG. 2, there is illustrated an apparatus for communicating electronic data via a network infrastructure 101 according to another preferred embodiment of the present invention. This embodiment is much similar to the one illustrated in FIG. 1, but here the apparatus also comprises an additional server 110, which is connected to the network infrastructure 101. As illustrated in FIG. 2, the means 103 for making said decision is included in the additional server 110. The additional server 110 may, for instance, be configured as a World Wide Web (www) server having links to the electronic data contained in the server 100. Otherwise, this embodiment illustrated in FIG. 2 is substantially similar to the embodiment in FIG. 1 and will therefore not be described further.

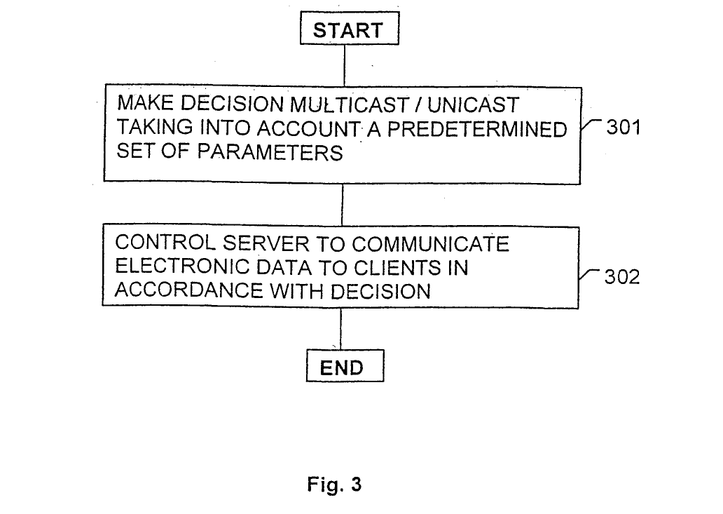

FIG. 3 illustrates, by means of a flow diagram, a general method according to the invention for communicating electronic data from a server to one or more clients via a network infrastructure having a unicast mechanism and; a multicast mechanism. The server contains electronic data and is capable of using said unicast and multicast mechanisms for communicating said electronic data to said one or more clients. A first step 301 makes a decision, taking into account a predetermined set of parameters, whether to use said unicast mechanism or said multicast mechanism for communicating said electronic data to said clients. The following step 302 controls said server to communicate said electronic data to said clients in accordance with said decision.

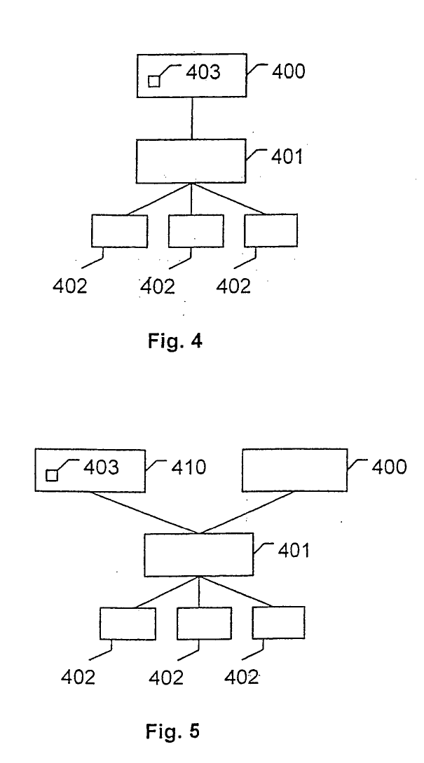

Now referring to FIG. 4, there is illustrated a system for secure multicasting of electronic data via a network infrastructure 401. Said network infrastructure 401 is preferably substantially similar to the network infrastructure 101 described above and will therefore not be described further. The system comprises a server 400 containing electronic data and a plurality of clients 402 to which said server 400 is adapted to multicast said electronic data. As illustrated, the server 400 is connected to the network infrastructure 401. Also the clients 402 are connected to the network infrastructure 401. In FIG. 4, three clients 402 are illustrated. However, at any given time the number of clients may be more or less than three. Each client 402 is adapted to communicate a first data encryption key to a device 403. The device 403 is in the illustrated embodiment included in the server 400. Furthermore, the device 403 is adapted to calculate a second data encryption key for each client 402 through a predetermined operation using a unique client identifier, preferably the IP address of the respective client 402, and said first data encryption key. The device 403 is adapted to communicate said second data encryption keys to each respective client 402. The server 400 is adapted to encrypt the electronic data to be communicated using a third encryption key corresponding to the difference between said first and second data encryption keys according to said predetermined operation. The server 400 is adapted to communicate the encrypted electronic data to each respective client 402. Each client 402 is adapted to create the third data encryption key using said first and second data encryption keys. Each client 402 is adapted to decrypt the communicated electronic data using the third data encryption key. Consequently, this solution is scalable, since it is applicable to any number of clients at any given time. Furthermore, since each client 402 receives a unique second data encryption key unauthorized copying of encryption keys between clients is prevented. Still, there is no need for encrypting the data to be communicated more than once, namely at the server 400 before communicating the data. Thus, there is no special requirement on hardware or software between-the server 400 and the clients 402 as regards encryption. The system thus provides secure multicasting of electronic data.

In an alternative embodiment shown in FIG. 5, much similar to the embodiment shown in FIG. 4, the system also comprises an additional server 410 and preferably said device 403 is included in the additional server 410. This is advantageous in that the server 400 then only needs to communicate encrypted electronic data to each client 402, while the additional server 410 takes care of the calculation and communication of encryption keys to each client 402.

To prevent data to be communicated to unauthorized clients, said device 403 is preferably adapted to communicate said second data encryption keys only to clients 402 sending RTCP (Real Time Control Protocol) messages containing receiver reports. Thus, clients not sending any receiver reports will not receive any keys and thereby unauthorized clients are not able to decrypt the communicated data.

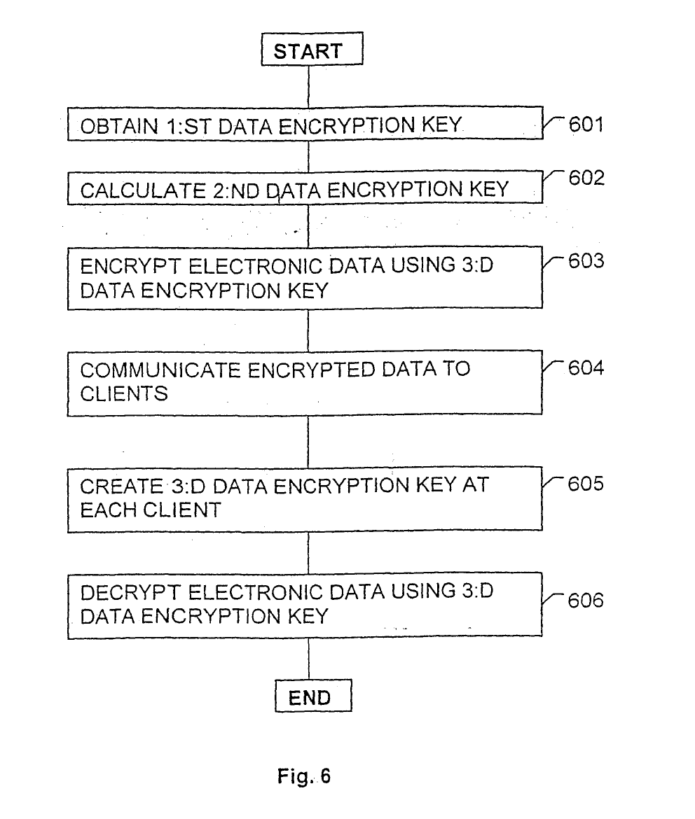

FIG. 6 illustrates, by means of a flow diagram, a general method for secure multicasting of electronic data from a server to a plurality of clients via a network infrastructure according to the invention. A first step 601 obtains first data encryption keys from each client, which are to receive electronic data. In a following step 602 second data encryption keys are calculated for each of the clients. Said second data encryption keys are calculated through a predetermined operation using a unique client identifier, preferably the IP address of the client, and said first data encryption key. A subsequent step 603 encrypts the electronic data to be communicated to each client. The data is encrypted using a third data encryption key,which corresponds to the difference between said first and second data encryption keys according to the predetermined operation. Then, in a step 604, the encrypted electronic data is communicated to each respective client. Thereafter, the third data encryption key is created at each of said clients using said first and second data encryption keys in a step 605. Finally, each client decrypts the communicated electronic data using said third data encryption key in a step 606.

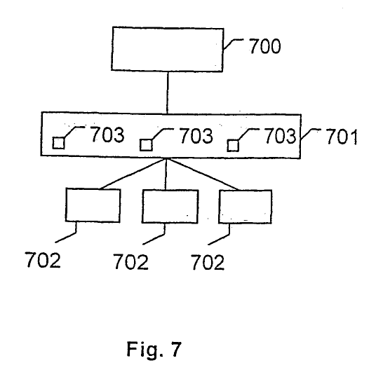

FIG. 7 illustrates a system for multicasting electronic data via a network infrastructure 701. Said network infrastructure 701 is preferably substantially similar to the network infrastructure 101 described above and will therefore not be described further. The system comprises a server 700 containing electronic data and a plurality of clients 702 to which the server 700 is adapted to multicast said electronic data. The server 700 is adapted to multicast said electronic data in a looped manner. For example, the electronic data to be multicast may be individual data streams representing some specific media content, such as for instance an audio or video clip. The term “looped manner” implies that when the electronic data has reached the end it starts over from the beginning again. If, for instance, the electronic data is a video clip, each client is able to wait until the beginning of the video clip before starting to watch. However, if the clip is very long, the time to wait until the playout of the electronic data reaches the beginning of the clip may become unacceptably long.

Therefore, according to a preferred embodiment of the present invention, the server 700 is adapted to multicast a plurality of data streams containing electronic data representing the same media content and multicast each data stream to a different multicast address 703. Furthermore, each data stream is arranged to start at a time different from the starting time of any other of said data streams. That is, the media content in said data streams are time shifted compared to each other. In this way, each client may choose to join the playout session, which reaches the starting point first, or to join the playout that has lasted the shortest time. That is, each client may join the multicast group, i.e. listen to the multicast address, to which the desired data is communicated from the server. Thus, at least nearly on-demand functionality is achieved.

If several time shifted data streams are multicast to a plurality of multicast addresses, an opportunity exists to achieve higher media quality for the clients. According to a preferred embodiment of the invention, each data stream is part of a layered encoding so that each individual data stream is encoded with a common base layer and a unique enhancement layer, which is different from the enhancement layer of any other of said data streams. Each client is adapted to combine the base layer of one data stream with enhancement layers from at least two different of said data streams thus obtaining a higher media quality. The obtaining of high media quality, however, requires a longer buffering time since the data streams are time shifted compared to each other.

According to yet another alternative embodiment of the present invention, the separate data streams are not time shifted compared to each other. According to this embodiment there is no need for longer buffering to achieve high media quality, but then the better on-demand functionality as described above may not be achieved.

The invention is of course not restricted to the embodiments described above, but many possibilities to modifications thereof may be envisaged by persons skilled in the art without departing from the scope of the invention as defined in the appended claims.

It is pointed out that many combinations of the embodiments described above are possible. For instance, the embodiments of the invention described with reference to FIGS. 1-3 may make use of the solution for achieving secure multicasting of electronic data as described with reference to FIGS. 4-6 as well as the solution for achieving on-demand functionality as described with reference to FIG. 7, when the decision is for said multicast mechanism to be used.

1. An apparatus for communicating electronic data via a network infrastructure (101; 401; 701) having a unicast mechanism and a multicast mechanism, said apparatus comprising a server (100; 400; 700), which contains electronic data and is capable of using said unicast and multicast mechanisms for communicating said electronic data to one or more clients (102; 402; 702), characterized in that it comprises means (103) adapted to make a decision, taking into account a predetermined set of parameters, whether said server (100; 400; 700) shall use said unicast mechanism or said multicast mechanism for communicating said electronic data to said clients (102; 402; 702) and that said server (100; 400; 700) is arranged to communicate said electronic data to said clients (102; 402; 702) in accordance with said decision, and that for providing secure data communication when said decision is for said multicast mechanism to be used for communicating said electronic data to said clients (102; 402; 702), each of said clients (102; 402; 702) is adapted to communicate a first data encryption key to a device (403), that said device (403) is adapted to calculate a second data encryption key for each of said clients (102; 402; 702) through a predetermined operation using a unique client identifier and said first data encryption key, that said device (403) is adapted to communicate said second data encryption keys to each respective client (102; 402; 702), that said server (100; 400; 700) is adapted to encrypt the electronic data to be communicated using a third data encryption key corresponding to the difference between said first and second data encryption keys according to said predetermined operation, that said server (100; 400; 700) is adapted to communicate the encrypted electronic data to each respective client (102; 402; 702), that each of said clients (102; 402; 702) is adapted to create said third data encryption key using said first and second data encryption keys, and that each of said clients (102; 402; 702) is adapted to decrypt the communicated electronic data using said third data encryption key.

2. An apparatus according to claim 1, characterized in that said means (103) is included in said server (100; 400; 700).

3. An apparatus according to claim 1 or 2, characterized in that it comprises an additional server (110; 410) and that said means (103) for making said decision is included in said additional server (110; 410).

4. An apparatus according to any of claims 1-3, characterized in that said means (103) is adapted to make said decision based on the number of client requests for said electronic data to be communicated from said server (100; 400; 700) per unit of time as one of said parameters.

5. An apparatus according to claim 4, characterized in that said means (103) is adapted to decide for said multicast mechanism to be used for communicating said electronic data to said clients (102; 402; 702) when said number of client requests for said electronic data to be communicated from said server (100; 400; 700) per unit of time is >=2 and otherwise for said unicast mechanism to be used.

6. An apparatus according to any of claims 1-5, characterized in that said means (103) is adapted to make said decision based on the number of client requests for a portion of said electronic data to be communicated from said server (100; 400; 700) as one of said parameters.

7. An apparatus according to claim 6, characterized in that said portion is an individual data stream.

8. An apparatus according to claim 6 or 7, characterized in that said means (103) is adapted to decide for said multicast mechanism to be used for communicating said portion to said clients (102; 402; 702) when the number of client requests for said portion of said electronic data to be communicated from said server (100; 400; 700) is >=2 and otherwise for said unicast mechanism to be used.

9. An apparatus according to any of claims 1-8, characterized in that said means (103) is adapted to make said decision based on the number of client requests for said electronic data to be communicated from said server (100; 400; 700) within the same distance from said server (100; 400; 700) as one of said parameters.

10. An apparatus according to claim 9, characterized in that said distance is defined by a TTL value.

11. An apparatus according to claim 9 or 10, characterized in that said means (103) is adapted to decide for said multicast mechanism to be used for communicating said electronic data to said clients (102; 402; 702) when the number of client requests for said electronic data to be communicated from said server (100; 400; 700) within the same distance from said server (100; 400; 700) is >=2 and otherwise for said unicast mechanism to be used.

12. An apparatus according to any of claims 1-11, characterized in that said means (103) is adapted to make said decision based on available server output bandwidth as one of said parameters.

13. An apparatus according to claim 12, characterized in that said means (103) is adapted to decide for said multicast mechanism to be used for communicating said electronic data to said clients (102; 402; 702) when available server output bandwidth is less than that required to communicate further electronic data as a response to a client request and otherwise for said unicast mechanism to be used.

14. An apparatus according to claim 1, characterized in that said device (403) is included in said server (100; 400; 700).

15. An apparatus according to claim 1, characterized in that said system comprises an additional server (110; 410) and that said device (403) is included in said additional server (110; 410).

16. An apparatus according to any of claims 1-15, characterized in that said unique client identifier is the IP address of the client (102; 402; 702).

17. An apparatus according to any of claims 1-16, characterized in that said device (403) is adapted to communicate said second data encryption keys only to clients (102; 402; 702) sending RTCP messages containing Receiver Reports.

18. An apparatus according to any of claims 1-17, characterized in that said server (100; 400; 700) is adapted to multicast said electronic data in a looped manner provided that said decision is for said multicast mechanism to be used for communicating said electronic data to said clients (102; 402; 702).

19. An apparatus according to claim 18, characterized in that said server (100; 400; 700) is adapted to multicast a plurality of data streams containing electronic data representing the same media content, that said server (100; 400; 700) is adapted to multicast each data stream to a different multicast address (703), and that each data stream is arranged to start at a time different from the starting time of any other of said data streams.

20. An apparatus according to claim 19, characterized in that each data stream is part of a layered encoding, that each data stream is encoded with a common base layer and a unique enhancement layer different from the enhancement layer of any other of said data streams, and that each client (102; 402; 702) is adapted to combine the base layer of one data stream with enhancement layers from at least two different of said data streams.

21. A method for communicating electronic data from a server (100; 400; 700) to one or more clients (102; 402; 702) via a network infrastructure (101; 401; 701) having a unicast mechanism and a multicast mechanism, said server (100; 400; 700) containing electronic data and being capable of using said unicast and multicast mechanisms for communicating said electronic data to said one or more clients (102; 402; 702), characterized by the steps of:
making a decision, taking into account a predetermined set of parameters, whether to use said unicast mechanism or said multicast mechanism for communicating said electronic data to said clients (102; 402; 702),
controlling said server (100; 400; 700) to communicate said electronic data to said clients (102; 402; 702) in accordance with said decision, and
for providing secure data communication when said decision is for said multicast mechanism to be used for communicating said electronic data to said clients (102; 402; 702), having the steps of:
obtaining a first data encryption key,
calculating a second data encryption key for each of said clients (102; 402; 702) through a predetermined operation using a unique client identifier and said first data encryption key, communicating said second data encryption keys to each respective client (102; 402; 702),
encrypting the electronic data to be communicated using a third data encryption key corresponding to the difference between said first and second data encryption keys according to said predetermined operation,
communicating the encrypted electronic data to each respective client (102; 402; 702),
creating said third data encryption key at each of said clients (102; 402; 702) using said first and second data encryption keys, and
decrypting the communicated electronic data at each of said clients (102; 402; 702) using said third data encryption key.

22. A method according to claim 21, characterized by making said decision based on the number of client requests for said electronic data to be communicated from said server (100; 400; 700) per unit of time as one of said parameters.

23. A method according to claim 22, characterized by deciding for said multicast mechanism to be used for communicating said electronic data to said clients (102; 402; 702) when said number of client requests for said electronic data to be communicated from said server (100; 400; 700) per unit of time is >=2 and otherwise for said unicast mechanism to be used.

24. A method according to any of claims 21-23, characterized by making said decision based on the number of client requests for a portion of said electronic data to be communicated from said server (100; 400; 700) as one of said parameters.

25. A method according to claim 24, characterized in that said portion is an individual data stream.

26. A method according to claim 24 or 25, characterized by deciding for said multicast mechanism to be used for communicating said portion to said clients (102; 402; 702) when the number of client requests for said portion of said electronic data to be communicated from said server (100; 400; 700) is >=2 and otherwise for said unicast mechanism to be used.

27. A method according to any of claims 21-26, characterized by making said decision based on the number of client requests for said electronic data to be communicated from said server (100; 400; 700) within the same distance from said server (100; 400; 700) as one of said parameters.

28. A method according to claim 27, characterized in that said distance is defined by a TTL value.

29. A method according to claim 27 or 28, characterized by deciding for said multicast mechanism to be used for communicating said electronic data to said clients (102; 402; 702) when the number of client requests for said electronic data to be communicated from said server (100; 400; 700) within the same distance from said server is >=2 and otherwise for said unicast mechanism to be used.

30. A method according to any of claims 21-19, characterized by making said decision based on available server output bandwidth as one of said parameters.

31. A method according to claim 32, characterized by deciding for said multicast mechanism to be used for communicating said electronic data to said clients (102; 402; 702) when available server output bandwidth is less than that required to communicate further electronic data as a response to a client request and otherwise for said unicast mechanism to be used.

32. A method according to claim 21, characterized in that said unique client identifier is the IP address of the client (102; 402; 702).

33. A method according to any of claims 21-32, characterized in that said second data encryption keys only are communicated to clients (102; 402; 702) sending RTCP messages containing Receiver Reports.

34. A method according to any of claims 21-33, characterized in that said multicast electronic data is looped provided that said decision is for said multicast mechanism to be used for communicating said electronic data to said clients (102; 402; 702).

35. A method according to claim 34, characterized in that a plurality of data streams containing electronic data representing the same media content are multicast, that each data stream is multicast to a different multicast address (703), and that each data stream starts at a time different from the starting time of any other of said data streams.

36. A method according to claim 35, characterized in that each data stream is part of a layered encoding, that each data stream is encoded with a common base layer and a unique enhancement layer different from the enhancement layer of any other of said data streams, and that each client (102; 402; 702) combines the base layer of one data stream with enhancement layers from at least two different of said data streams.

37. A computer program directly loadable into the internal memory of a computer, comprising software for controlling the steps of any of claims 21-36 when said program is run on the computer.

38. A computer program according to claim 37, provided at least partially through a network as the Internet.

39. A computer readable medium, having a program recorded thereon, where the program is to make a computer control the steps of any of the claims 21-36.

40. A method for secure multicasting of electronic data from a server (400) to a plurality of clients (402) via a network infrastructure (401), characterized by the steps of:
obtaining a first data encryption key,
calculating a second data encryption key for each of said clients (402) through a predetermined operation using a unique client identifier and said first data encryption key,
communicating said second data encryption keys to each respective client (402), said second data encryption keys only being communicated to clients (402) sending RTCP messages containing Receiver Reports,
encrypting the electronic data to be communicated using a third data encryption key corresponding to the difference between said first and second data encryption keys according to said predetermined operation,
communicating the encrypted electronic data to each respective client (402),
creating said third data encryption key at each of said clients (402) using said first and second data encryption keys, and
decrypting the communicated electronic data at each of said clients (402) using said third data encryption key.

41. A method according to claim 40, characterized in that said unique client identifier is the IP address of the client (402).

42. A computer program directly loadable into the internal memory of a computer, comprising software for controlling the steps of any of claims 40 or 41 when said program is run on the computer.

43. A computer program according to claim 42, provided at least partially through a network as the Internet.

44. A computer readable medium, having a program recorded thereon, where the program is to make a computer control the steps of any of the claims 40 or 41.

45. A system for secure multicasting of electronic data via a network infrastructure (401), said system comprising a server (400) containing electronic data and a plurality of clients (402) to which said server (400) is adapted to multicast said electronic data, characterized in that each of said clients (402) is adapted to communicate a first data encryption key to a device (403), that said device (403) is adapted to calculate a second data encryption key for each of said clients (402) through a predetermined operation using a unique client identifier and said first data encryption key, that said device (403) is adapted to communicate said second data encryption keys to each respective client (402), said device (403) being adapted to communicate said second data encryption keys only to clients (402) sending RTCP messages containing Receiver Reports, that said server (400) is adapted to encrypt the electronic data to be communicated using a third data encryption key corresponding to the difference between said first and second data encryption keys according to said predetermined operation, that said server (400) is adapted to communicate the encrypted electronic data to each respective client (402), that each of said clients (402) is adapted to create said third data encryption key using said first and second data encryption keys, and that each of said clients (402) is adapted to decrypt the communicated electronic data using said third data encryption key.

46. A system according to claim 45, characterized in that said device (403) is included in said server (400).

47. A system according to claim 45, characterized in that said system comprises an additional server (410) and that said device (403) is included in said additional server (410).

48. A system according to any of claims 45-47, characterized in that said unique client identifier is the IP address of the client (402).

49. A method for multicasting electronic data from a server (700) to one or more clients (702) via a network infrastructure (701), characterized in that said multicast electronic data is looped, and a plurality of data streams containing electronic data representing the same media content are multicast, that each data stream is multicast to a different multicast address (703), and that each data stream starts at a time different from the starting time of any other of said data streams.

50. A method according to claim 49, characterized in that each data stream is part of a layered encoding, that each data stream is encoded with a common base layer and a unique enhancement layer different from the enhancement layer of any other of said data streams, and that each client (702) combines the base layer of one data stream with enhancement layers from at least two different of said data streams.

51. A computer program directly loadable into the internal memory of a computer, comprising software for controlling the steps of any of claims 49 or 50 when said program is run on the computer.

52. A computer program according to claim 51, provided at least partially through a network as the Internet.

53. A computer readable medium, having a program recorded thereon, where the program is to make a computer control the steps of any of the claims 49 or 50.

54. A system for multicasting electronic data via a network infrastructure (701), said system comprising a server (700) containing electronic data and a plurality of clients (702) to which said server (700) is adapted to multicast said electronic data, characterized in that said server (700) is adapted to multicast said electronic data in a looped manner, and said server (700) is adapted to multicast a plurality of data streams containing electronic data representing the same media content, that said server (700) is adapted to multicast each data stream to a different multicast address (703), and that each data stream is arranged to start at a time different from the starting time of any other of said data streams.

55. A system according to claim 54, characterized in that each data stream is part of a layered encoding, that each data stream is encoded with a common base layer and a unique enhancement layer different from the enhancement layer of any other of said data streams, and that each client (702) is adapted to combine the base layer of one data stream with enhancement layers from at least two different of said data streams.

56. A method for multicasting electronic data from a server (700) to one or more clients (702) via a network infrastructure (701), characterized by the steps of:
encoding a plurality of data streams containing electronic data representing the same media content according to a layered encoding so that each of said data streams is encoded with a common base layer and a unique enhancement layer different from the enhancement layer of any other of said data streams,
multicasting each of said data streams to a different multicast address (703), and
combining the base layer of one data stream with enhancement layers from at least two different of said data streams.
